(19) United States
(12) Patent Application Publication
(10) Pub. No.: US 2024/0402324 A1
(43) Pub. Date: Dec. 5, 2024

(54) MIMO RADAR APPARATUS AND MIMO RADAR METHOD

(71) Applicant: Infineon Technologies AG, Neubiberg (DE)

(72) Inventors: Philipp SCHERZ, Traun (AT); Markus Josef LANG, Putzleinsdorf (AT); Ulrich MOELLER, Holzkirchen (DE); Clemens PFEFFER, Linz (AT)

(21) Appl. No.: 18/669,205

(22) Filed: May 20, 2024

(30) Foreign Application Priority Data
Jun. 2, 2023 (DE) 102023205198.2

(51) Int. Cl. G01S 13/32; G01S 7/35; G01S 13/34

(52) U.S. Cl. CPC G01S 13/325; G01S 7/35; G01S 13/343

(57) ABSTRACT

A radar apparatus includes a transmitter circuit. The transmitter circuit is configured to transmit, via a first transmit channel, a first sequence of FMCW radar chirps, and to transmit, via at least a second transmit channel, a second sequence of FMCW radar chirps concurrently with the first sequence of FMCW radar chirps. The radar apparatus includes a control circuit configured to control the first and second transmit channels to set phases of the FMCW radar chirps of the first and second sequences in accordance with a phase modulation scheme that includes a first unique phase code sequence assigned to the first sequence of FMCW radar chirps, and a second unique phase code sequence assigned to the second sequence of FMCW radar chirps. The first unique phase code sequence is combined with a scrambling phase code sequence. The second unique phase code sequence is combined with the scrambling phase code sequence.

### CROSS-REFERENCE TO RELATED APPLICATION

This application claims priority to German Patent Application No. 102023205198.2 filed on Jun. 2, 2023, the content of which is incorporated by reference herein in its entirety.

### TECHNICAL FIELD

The present disclosure relates to radar systems and, more particularly, to Multi Input Multi Output (MIMO) radar concepts employing multiple transmit channels, one or multiple receive channels, and multiple waveforms.

### BACKGROUND

Automotive radars, along with other environmental sensors such as lidar, ultrasound, and cameras, are one of the backbones of self-driving cars and advanced driver assistant systems (ADASs). These technological advancements are enabled by complex systems with signal processing paths from radars/sensors to one or more controllers. Automotive radar systems enable the detection of objects and obstacles, their position and speed relative to a vehicle. The development of signal processing techniques along with progress in the millimeter-wave (mm-wave) semiconductor technology plays a key role in automotive radar systems. Various signal processing techniques have been developed to provide better resolution and estimation performance in all measurement dimensions: range, azimuth-elevation angles, and velocity of the targets surrounding the vehicles.

For frequency-modulated continuous-wave (FMCW) radar systems, for example, it is known to obtain information on range, speed, and angles by performing multiple Fast Fourier Transforms (FFTs) on samples of radar mixer outputs. A first FFT, also commonly referred to as range FFT, yields range information. A second FFT across the range transformed samples, also commonly referred to as Doppler FFT, yields speed information. The first and second FFTs yield a so-called 2D range-Doppler map comprising range and speed (FFT) bins. A third FFT involving phase information of signals of different antenna elements of an (virtual) antenna array can yield additional spatial or angular information-so-called Direction-of-Arrival (DoA) information.

MIMO (Multi Input Multi Output) is widely used to enlarge effective radar aperture size by synthesizing a virtual receiver array by combination of physically implemented multiple transmitter channels and multiple receiver channels. To synthesize virtual array information from limited physical arrays, separation of reflected signals received at each receiver channel from different transmitters is an important procedure in MIMO technology. A similar level of importance is on identification of corresponding transmitters of every reflected signal in each receiver channel.

Doppler Division Multiplexing (DDM) which may also be referred to as Code Division Multiplexing (CDM) is a popular slow-time modulation technique for automotive MIMO radars. In DDM, FMCW radar chirps concurrently transmitted by different transmit channels are modulated by different transmit-channel-specific sequences of phases, so that the respective receive signals can be separated/decoded in a receiver based on the respective sequences of phases. DDM requires accurate transmit phase shifters to avoid artifacts such as spurs that would degrade the radar system's performance. Inaccuracy of the transmit phase shifters may create spurs along the axis of velocity, thus limiting the number of transmitters that can be switched on at the same time.

Thus, there is a need for apparatuses and methods that can reduce the problem of inaccuracy of the transmit phase shifters.

### SUMMARY

This demand is met by radar apparatuses and methods in accordance with the appended claims.

According to a first aspect, the present disclosure proposes a radar apparatus. The radar apparatus includes a transmitter circuit which includes a plurality of transmit channels. The transmitter circuit is configured to transmit a first sequence of FMCW radar chirps via a first transmit channel and to transmit, via at least a second transmit channel, at least a second sequence of FMCW radar chirps concurrently with the first sequence of FMCW radar chirps. A sequence of FMCW radar chirps may include P chirps and may also be referred to as a frame of FMCW radar chirps. The radar apparatus further includes a control circuit configured to control the first and second transmit channels to set phases of the FMCW radar chirps of the first sequence (frame) and the second sequence (frame) in accordance with a phase modulation scheme. The phase modulation scheme may be a DDM or CDM scheme. The phase modulation scheme includes a first (predetermined and) unique phase code sequence assigned to the first sequence of FMCW radar chirps according to the phase modulation scheme. Additionally, the first unique phase code sequence is combined with a scrambling phase code sequence. The phase modulation scheme includes at least a second (predetermined and) unique phase code sequence assigned to the second sequence of FMCW radar chirps according to the phase modulation scheme. Additionally, the second unique phase code sequence is combined with the scrambling phase code sequence. Thus, implementations of the present disclosure are based on the idea of imposing a (pseudo-) random phase sequence (scrambling phase code sequence) on a classical DDM modulation from chirp to chirp. In this way, phase modulator errors may be distributed more evenly over the unit circle.

Here, the scrambling phase code sequence denotes a sequence of phase values that may be superimposed with the first and second unique or transmit-channel-specific phase code sequences of the phase modulation scheme. The scrambling phase code sequence is the same for all transmit channel specific unique phase code sequences of the phase modulation scheme. The scrambling phase code sequence may include (pseudo-) random scrambling phase code values or a (pseudo-) random order of scrambling phase code values.

The first and second sequences of FMCW radar chirps may each include P chirps per frame. Typically, P may be selected as a power of 2, e.g., P=1024. Consequently, the first and second unique phase code sequences may also each include P phase values, e.g., one phase value per chirp. In some implementations, the scrambling phase code sequence may include M·P phase values, where M is an integer larger than or equal to 1. If M>1, then each chirp has associated therewith more than one (M) scrambling phase code value. If M=1, then each chirp has associated therewith exactly one scrambling phase code value. In some implementations, the scrambling phase code sequence may also include P/M phase values, where M is an integer larger than or equal to 1. In the latter case, M chirps have associated therewith one common scrambling phase code value.

In some implementations, an p-th (p≤P) phase value of the first unique phase code sequence is combined with an p-th phase value of the scrambling phase code sequence to obtain an p-th combined phase for the first transmit channel. Likewise, an p-th phase value of the second unique phase code sequence is combined with the p-th phase value of the scrambling phase code sequence to obtain an p-th combined phase for the second transmit channel. The type of combination of the p-th phase value of the scrambling phase code sequence and the p-th phase value of the first/second unique phase code sequence may be identical. For example, the p-th phase value of the scrambling phase code sequence may be added to (or subtracted from) the p-th phase value of the first unique phase code sequence to obtain the p-th combined phase for the first transmit channel. Likewise, the p-th phase value of the scrambling phase code sequence may also be added to (or subtracted from) the p-th phase value of the second unique phase code sequence to obtain the p-th combined phase for the second transmit channel.

In some implementations, the control circuit is configured to select phase values of the scrambling phase code sequence in a range from 0° to 360° (0 to 2π). In this way, phase modulator errors may be distributed evenly over the whole unit circle. The control circuit may be is configured to control a first phase modulator to set the combined phase for the first transmit channel and to control a second modulator to set the combined phase for the second transmit channel.

In some implementations, the control circuit is configured to select phase values of the scrambling phase code sequence in accordance with a random distribution in a range from 0° to 360°. That is, the phase values of the scrambling phase code sequence may be random values in the range from 0° to 360°. In this way, phase modulator errors may be distributed approximately evenly over the whole unit circle.

In some implementations, the control circuit is configured to the select phase values of the scrambling phase code sequence as uniformly distributed phases in a range from 0° to 360° and randomly distributed within the scrambling phase code sequence. Here, the phase values of the scrambling phase code sequence themselves are not random. For example, the phase values of the scrambling phase code sequence may be evenly distributed in the range from 0° to 360°. However, positions of the uniformly distributed phase values within the scrambling phase code sequence may be random. In this way, phase modulator errors may be distributed evenly over the whole unit circle.

In some implementations, the control circuit is configured to apply the scrambling phase code sequence to both the first and to the second sequence of FMCW radar chirps in a first time interval. The first time interval may correspond to a first frame of N chirps. Further, the control circuit is configured to apply the same scrambling phase code sequence to the first and to the second sequence of FMCW radar chirps in a subsequent second time interval. The second time interval may correspond to a subsequent second frame of N chirps. That is, the scrambling phase code sequence applied to all transmit channels may remain constant over time.

In some implementations, the radar apparatus further includes a memory circuit configured to store the first and the second unique phase code sequence and/or the scrambling phase code sequence. This means that the scrambling phase code sequence may be predefined and thus stored in the memory circuit.

In some implementations, the control circuit is configured to apply a first scrambling phase code sequence to the first and to the second sequence of FMCW radar chirps in a first time interval. The first time interval may correspond to a first frame of P chirps. Further, the control circuit is configured to apply a different second scrambling phase code sequence to the first and to the second sequence of FMCW radar chirps in a subsequent second time interval. The second time interval may correspond to a subsequent second frame of P chirps. That is, the scrambling phase code sequence applied to all transmit channels may change over time. This may further improve an even distribution of phase modulator errors.

In some implementations, the radar apparatus further includes a random number generator configured to generate one or more scrambling phase code sequences for different subsequent time intervals. This means that the scrambling phase code sequence may not be predefined and thus newly generated for subsequent time intervals.

In some implementations, the control circuit is configured to select phase values of the first and second unique phase code sequence from an M-ary phase modulation alphabet, wherein M≥2 is an integer. For example, the modulation alphabet may be a binary modulation alphabet, a ternary modulation alphabet, an 8-ary modulation alphabet, etc.

In some implementations, the radar apparatus further includes a receiver circuit including at least one receiver channel configured to receive a receive signal corresponding to reflections of the first sequence of FMCW radar chirps and the second sequence of FMCW radar chirps. The receiver circuit is configured to perform a back-transformation based on the receive signal using the scrambling phase code sequence. This back-transformation may be performed in the time domain and/or in the frequency domain.

According to a further aspect, the present disclosure proposes a radar method. The radar method includes transmitting a first sequence of FMCW radar chirps via a first transmit channel, and transmitting at least a second sequence of FMCW radar chirps concurrently with the first sequence of FMCW radar chirps via at least a second transmit channel. The radar method further includes controlling the first and second transmit channels to set phases of the FMCW radar chirps of the first sequence (frame) and the second sequence (frame) in accordance with a phase modulation scheme. The phase modulation scheme may be a DDM or CDM scheme. The radar method includes assigning a first (predetermined and) unique phase code sequence to the first sequence of FMCW radar chirps according to the phase modulation scheme. The radar method further includes combining the first unique phase code sequence with a scrambling phase code sequence. The radar method includes assigning a second (predetermined and) unique phase code sequence to the second sequence of FMCW radar chirps according to the phase modulation scheme. The radar method further includes combining the second unique phase code sequence with the scrambling phase code sequence.

### BRIEF DESCRIPTION OF THE DRAWINGS

Some examples of apparatuses and/or methods will be described in the following by way of example only, and with reference to the accompanying figures, in which:

FIG. 1 shows a block diagram of a conventional radar signal processing chain;

FIG. 2 shows a 2D joint range-Doppler estimation with FMCW radar; Fig. index for y axis is mile/hour while x axis in meters;

FIG. 3 illustrates azimuth angle estimation using a uniform linear antenna array;

FIG. 4 illustrates a concept of virtual array synthesis;

FIG. 5A shows a Time Division Multiple Access (TDMA) MIMO radar transmission method;

FIG. 5B shows a Code Division Multiple Access (CDMA) MIMO radar transmission method;

FIG. 6 illustrates a block diagram of a radar apparatus in accordance with an implementation of the present disclosure;

FIG. 7 illustrates an example of a conventional DDM scheme;

FIG. 8A shows an ideal Range-Doppler Map for four transmit channels and two targets;

FIG. 8B shows Range-Doppler Maps showing additional spurs for four transmit channels and two targets;

FIG. 9A illustrates an example of a proposed scrambled DDM scheme;

FIG. 9B shows an ideal Range-Doppler Map for four transmit channels and two targets for the proposed scrambled DDM scheme;

FIG. 10 shows a receive signal before and after demodulation (descrambling);

FIG. 11A shows a Range-Doppler Map with additional spurs for four transmit channels and two targets;

FIG. 11B shows Range-Doppler Maps with reduced spurs for four transmit channels and two targets; and

FIG. 12 shows Doppler bins with additional spurs and with reduced spurs for four transmit channels and two targets.

### DETAILED DESCRIPTION

Some examples are now described in more detail with reference to the enclosed figures. However, other possible examples are not limited to the features of these implementations described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

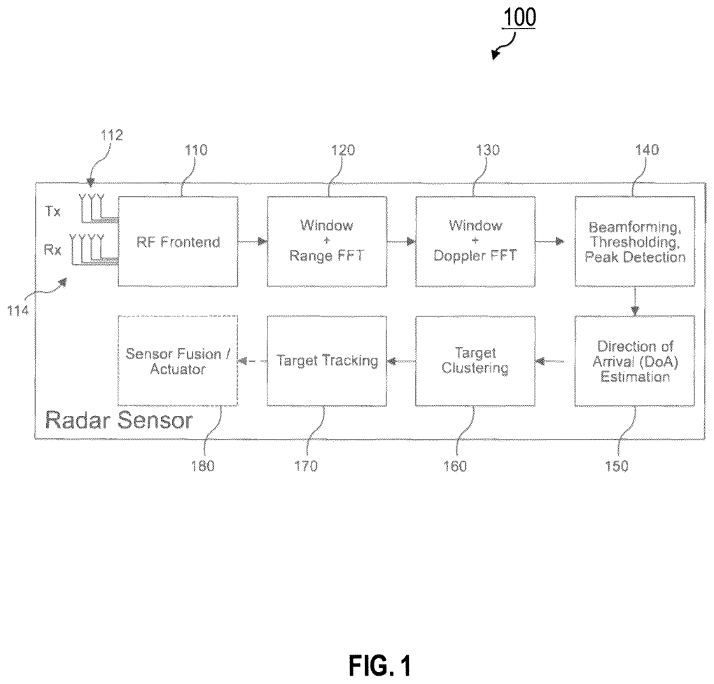

FIG. 1 shows a block diagram of a conventional radar signal processing chain 100.

A Radio Frequency (RF) transceiver frontend 110 is used to generate transmit (Tx) radar signals that can be emitted via one or more transmit antennas 112. Thus, transceiver frontend 110 comprises transmitter circuitry with one or more transmit channels. The radar signals can be in frequency bands ranging from 3 MHz to 300 GHz. Automotive radar systems typically operate at bands in 24 GHz and 77 GHz portions of the electromagnetic spectrum known as mm-wave frequencies so that adequate velocity and range resolution can be achieved. One or more receive (Rx) antennas 114 are used to receive electromagnetic waves (radar signals) reflected from targets. Thus, transceiver frontend 110 also comprises receiver circuitry with one or more receive channels. Radar operation involves range (distance), relative velocity, and possibly direction estimation. The latter can be done when using more than one receive antenna in an receive antenna array. Radar systems using both multiple transmit and multiple receive antennas are commonly referred to as MIMO radars. For proper transmit antenna spacing, the multiple-input multiple-output (MIMO) radar can emulate a larger aperture phased array radar. This larger array can be called a virtual array.

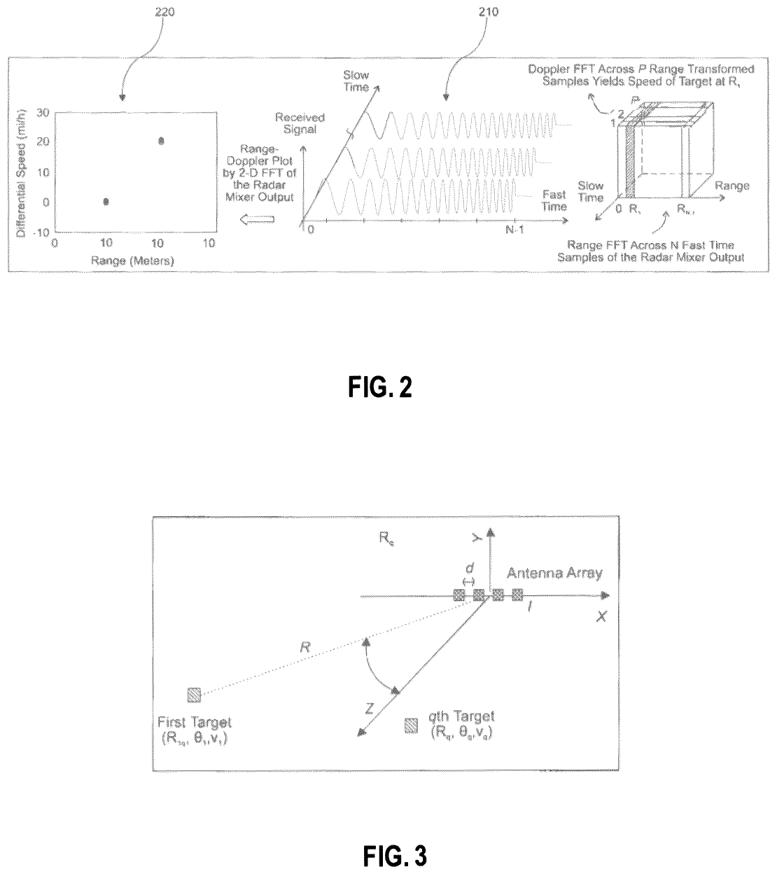

A range processor 120 downstream from the RF transceiver frontend 110 is configured to perform range estimation. A range R to a target, can be determined based on the round-trip time delay that the electromagnetic waves take to propagate to and from that target: R=(cτ/2), where τ is the round-trip time delay in seconds and c is the speed of light in meters per second. Thus, the estimation of τ enables the range measurement. For example, pulse-modulated continuous waves (CWs) can comprise periodic and short power pulses and silent periods. Silent periods allow the radar to receive the reflected signals and serve as timing marks for radar to perform range estimation. With a pulsed radar configuration that uses frequency modulated (FM) CW pulses, simultaneous range-velocity estimation in multitarget traffic scenarios can be provided. A FMCW radar transmits periodic FM chirps (also referred to as pulses or ramps), whose frequency may increase linearly during the pulse. The receive signal reflected from a target is conjugately mixed with the transmit signal to produce a low-frequency beat signal (also referred to as baseband signal), whose frequency gives the range of the target. This operation can be repeated for P consecutive FMCW chirps. Two-dimensional (2D) waveforms 210 in FIG. 2 depict successive reflected chirps arranged across two time indices p, n. The so-called slow time index p simply corresponds to the chirp number. On the other hand, the so-called fast time index n assumes that for each chirp, the corresponding continuous beat signal is sampled with frequency fₛ to collect N samples within a chirp duration T.

The range processor 120 can be configured to perform a first discrete Fourier transform (e.g., FFT) across the fast time n to obtain beat frequency f_{b} coupled with Doppler frequency f_{d}. This operation is also commonly known as range transform or range gating, which allows the estimation of Doppler shift corresponding to unique range gate or bin by the application of second Fourier transform (e.g., FFT) across the slow time. This can be done by speed processing element 130. Thus, a range-Doppler map 220 can be generated by using a 2D FFT, see FIG. 2. An example range-Doppler map 220 illustrated in FIG. 2 shows two targets, a first one at 10 m distance and 0 miles/hour relative speed, and a second one at 20 m distance at 20 mi/h relative speed. The targets can be subregions of interest of the range-Doppler map.

So far, it has been assumed that automotive radars only receive the reflection from the targets of interest, such as vehicles traveling in front. However, in addition to direct reflections from a target of interest, the radar also receives reflections from the road debris, guard rails, and walls, for example. This unwanted return at the radar is typically called clutter. The amount of clutter in the system changes as the surrounding environment of the vehicle varies. Hence, adaptive algorithms such as constant false alarm rate (CFAR) processing and space-time adaptive processing (STAP) can be used to mitigate the effect of clutter. To identify valid targets in the presence of clutter, a threshold for the target detection should be properly chosen. If the amplitude of the range-Doppler map at an estimated range is greater than some threshold, for example, the target can be the to be detected. Thus, the threshold should depend on the noise (e.g., clutter) in the given system. As clutter increases, a higher threshold may be chosen. A simple CFAR method based on cell or bin averaging can use a sliding window to derive the local clutter level by averaging multiple range bins. This described threshold selection and target (peak) detection is performed in processing block 140.

The use of wideband pulses, such as FMCW pulses, provides discrimination of targets in both distance and velocity. The discrimination in direction can be made using a multi-antenna array, such as in multi-antenna radar systems. Multi-antenna radar systems can employ multiple transmitters, multiple receivers, and multiple waveforms to exploit all available degrees of freedom. To spatially resolve targets and deliver comprehensive representation of the traffic scene, angular location of targets can be estimated. Therefore, in automotive radars, the location of a target can be described in terms of a spherical coordinate system (R, θ, p), where (θ, p) denote azimuthal and elevation angles, respectively. A single antenna radar setup is sufficient to provide a range-velocity map but insufficient to provide angle information since the measured time delay lacks the information in terms of angular locations of the targets. To enable direction estimation, the radar is configured to receive reflected waves with multiple antennas. For example, locating a target using electromagnetic waves in two dimensions requires the reflected wave data from the object to be collected in two distinct dimensions. These distinct dimensions can be formed in many ways using combinations of time, frequency, and space across receive antennas. For instance, a linear receive antenna array 114 and wideband waveforms such as FMCW form two unique dimensions. Additionally, smaller wavelengths in mm-wave bands correspond to smaller aperture sizes and, thus, many antenna elements can be densely packed into an antenna array. Hence, the effective radiation beam, which is stronger and sharper, in turn increases the resolution of angular measurements.

Consider an antenna array located in plane z=0, and let/be the abscissa corresponding to each receiver antenna position, see FIG. 3. Let (R_{q}, θ_{q}) be the position of the q-th target in spherical coordinates, moving with velocity v_{q} relative to the radar. With the help of far field approximation, for the q-th target, the round-trip time delay between a transmitter located at the origin and the receiver positioned at coordinate/can be expressed by

$${τ}_{lq} = \frac{2 ( {R}_{q} + {v}_{q} t ) + ld sin {θ}_{q}}{c} ,$$

where d is the distance between antenna elements (usually half the wavelength) arranged in a linear constellation. The delay term τ_{lq} creates uniform phase progression across antenna elements, which permits the estimation of the angle θ_{q} by FFT in spatial domain. Thus, 2D location (range and angle) and speed of targets can be estimated by a 3D FFT. The third angular FFT (Direction-of-Arrival, DoA, processing) is performed in processing block 150 of the example radar signal processing block diagram of FIG. 1.

Further conventional automotive radar processing can include target clustering 160, target tracking 170, and optional sensor fusion 180 with sensor data of other environmental sensor types (e.g., camera, lidar, etc.).

MIMO radar systems employ multiple transmitters, multiple receivers, and multiple waveforms to exploit all available degrees of freedom. MIMO radars can be classified as widely separated or co-located. In widely separated MIMO radar, transmit-receive antennas capture different aspects of the radar cross section (RCS) of a target. In other words, the target appears to be spatially distributed, providing a different RCS at each antenna element. This RCS diversity can be utilized to improve the radar performance. On the other hand, with co-located MIMO radar, the RCS observed by each antenna element is indistinguishable.

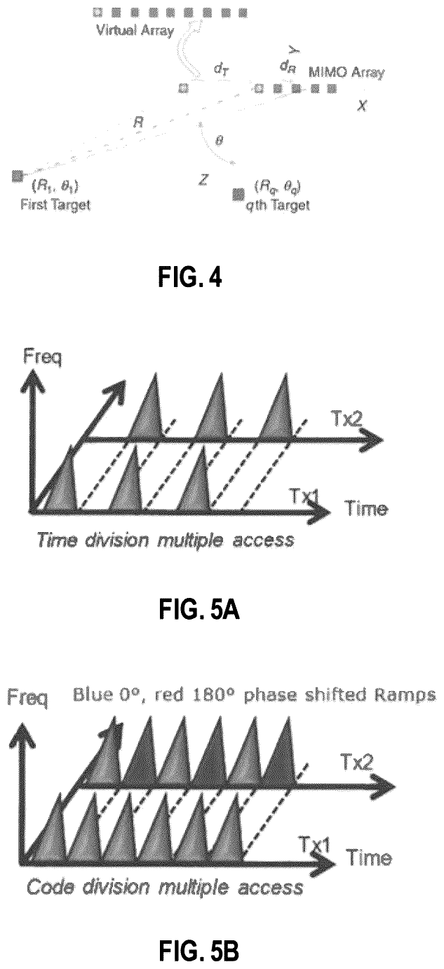

Automobiles typically use co-located MIMO radars, which are compact in size. For proper transmitter spacing, the co-located MIMO radar can emulate a larger aperture phased array radar, see FIG. 4. This larger array is called a virtual array. For the MIMO radar processing, as depicted in FIG. 4, a 1-D receiver (Rx) array with two transmit (Tx) antennas is considered. Let N_{T} and N_{R} denote a number of Tx and Rx antenna elements, respectively. Suppose that d_{T} and d_{R} represent corresponding Tx and Rx antenna spacings. Also, assume that Tx and Rx antenna positions in Cartesian coordinates are given by I_{T} and I_{R}. Hence, the 2-D FMCW mixer output signal across fast time and aperture can be denoted as

$$d ( {l}_{T} , {l}_{R} , n ) \approx {\sum }_{q = 0}^{Q - 1} {α}_{q} exp \{ j 2 π [ \frac{2 {KR}_{q}}{c} \frac{n}{{f}_{s}} + \frac{{f}_{c} \{ ( {l}_{T} {d}_{T} + {l}_{R} {d}_{R} ) sin {θ}_{q} \}}{c} + \frac{2 {f}_{c} {R}_{q}}{c} ] \} + ω ( {l}_{T} , {l}_{R} , n )$$

From above equation, it is evident that if d_{T}=N_{R}×d_{R}, then MIMO radar imitates a regular 1-D array radar with a single Tx and N_{T}×N_{R} Rx antenna elements. This is known as virtual array representation. Hence, the spatial resolution of FFT-based target imaging can be improved by the factor of N_{T}.

A challenging aspect of MIMO radar is the selection of waveforms. The waveforms can be made orthogonal in frequency, time, or code domain, for example.

For a MIMO radar, to easily separate the signals transmitted by different Tx antennas (Tx channels), the most intuitive and simple way is alternative transmitting, e.g., each Tx channel transmits its own waveform alternatingly, and there is no overlap between any two transmissions. This is illustrated in FIG. 5A. This alternative transmitting Time Division Multiplexing (TDM) approach can achieve ideal orthogonality and the conventional radar waveform (e.g., chirp waveform) can be directly used in all transmitters. Though this alternative transmitting TDM approach is easy to use, it is evident that the transmission capabilities of all Tx antennas are not fully utilized. Compared with the MIMO radar in which all Tx antennas can transmit simultaneously, this alternative transmitting approach suffers from a loss of transmit power, which will give a shorter target detection range (Processing gain will be same or detection ranges are same, at the cost of Doppler unambiguity range reduction at TDM).

Doppler Division Multiplex (DDM) (also referred to as Code Division Multiplexing, CDM) MIMO waveform means the signals transmitted by different Tx channels are modulated by different series of phase codes, either in fast time or in slow time, so that these signals can be separated/decoded in a radar receiver. Since an ideal orthogonal code sequence with good auto- and cross-correlation properties does not exist, the DDM MIMO waveforms can just approximately satisfy the orthogonality requirement. In fast-time DDM (CDM) waveform, the phase codes are modulated by the carrier signal within each pulse/chirp. In slow-time DDM waveform, the phase codes are used to modulate the initial phases of different chirps. FIG. 5B illustrates an example of a slow-time DDM (CDM) waveform where chirps from transmit channel Tx1 and transmit channel Tx2 are transmitted concurrently. However, Tx2 applies a different phase code than Tx1. In the illustrated example, the initial phase of every second chirp of Tx2 is 180°, while Tx1 applies an initial phase of 0° for every chirp.

A problem of DDM is that the (analog) phase shifters 622 must be able to adjust the phases of the high-frequency transmitted signal very precisely (e.g., <1°), otherwise harmonic spurs may occur along the velocity axis. Since each modulated transmit channel generates numerous spurs, a large number of spurs can occur with a 4-fold transmitter per target. A problem is that the resulting spurs must all be classified and sorted out by the signal processing. Especially with targets at similar distances, this may be very difficult and there is always the danger that actual targets can be confused with spurs. Another problem is that harmonic spurs often come to lie on target peaks of another transmitter and thus distort the phase and amplitude of the actual peak.

Thus, there is a need for apparatuses and methods that can reduce the problem of inaccuracy of the transmit phase shifters 622.

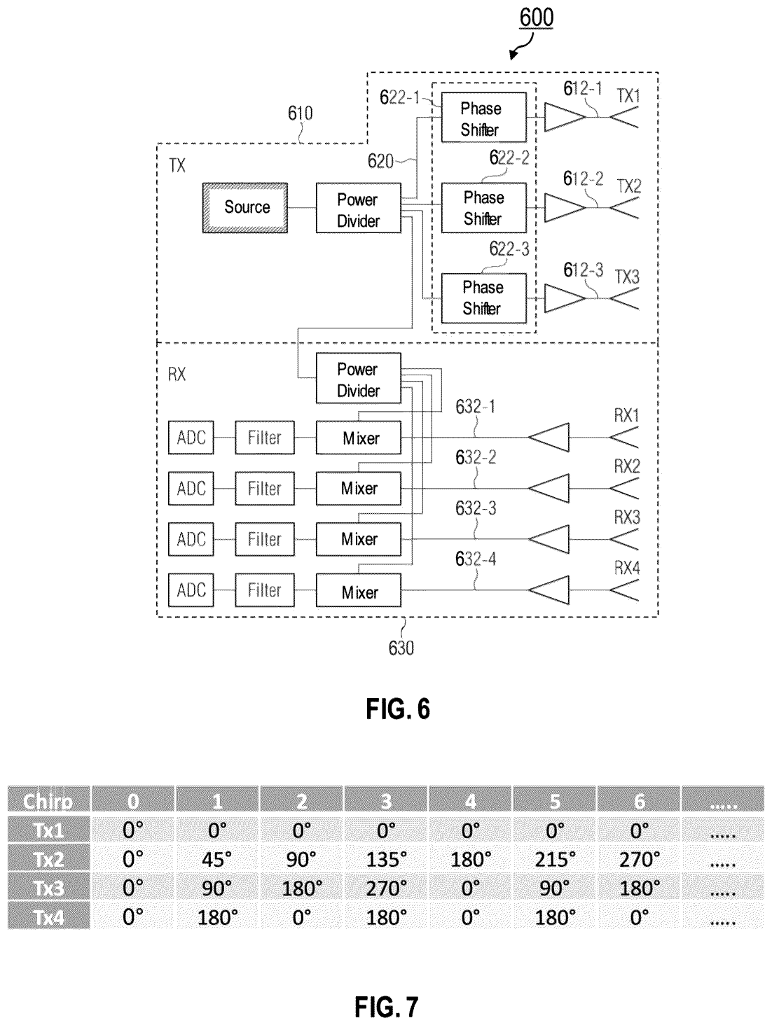

FIG. 6 illustrates a block diagram of a radar apparatus 600 in accordance with an implementation of the present disclosure.

Radar apparatus 600 comprises a transmitter circuit 610. Transmitter circuit 610 comprises a plurality of Tx channels 612-1, 612-2, 612-3. Although only three Tx channels are depicted in FIG. 6, the skilled person having benefit from the present disclosure will appreciate that an arbitrary number of Tx channels is possible. For example, there could be only two Tx channels 712-1, 712-2. However, there also could be four or more Tx channels. Each Tx channel may comprise digital and/or analog hardware components, such as power splitters, phase shifters, power amplifiers, and Tx antennas.

The transmitter circuit 610 is configured to transmit, via the first Tx channel 612-1, a first sequence (frame) of FMCW radar chirps (ramps). Start and/or stop frequencies of each of the FMCW radar chirps of the first chirp sequence may be equal or may be different (offset) from each other. Further, the transmitter circuit 610 is configured to transmit, via the second Tx channel 612-2, a second sequence (frame) of FMCW radar chirps (ramps). Again, start and/or stop frequencies of each of the FMCW radar chirps of the second chirp sequence may be equal or may be different (offset) from each other. It is to be noted that the first Tx channel 612-1 and the second Tx channel 612-2 are operated simultaneously. Thus, the first and the second sequence of FMCW radar chirps may be transmitted concurrently and synchronously. In other words, the FMCW radar chirps of the first and the second chirp sequence may be transmitted concurrently and synchronously.

As the first and the second sequence of FMCW radar chirps may be transmitted concurrently, there is a need for separation of signals from the first Tx channel 612-1 and the second Tx channel 612-2 at a receiving portion 630 of radar apparatus 600. As has been explained before, this can be achieved via Doppler Division Multiplexing (DDM). Doppler Division Multiple Access (DDMA) is an inter-chirp phase coding scheme (“slow-time” coding). In this configuration, the signal spectrum of each Tx channel is shifted slightly, so that the waveforms of different TX channels can be separated in Doppler domain.

For this purpose, MIMO radar apparatus 600 further comprises a control circuit 620 configured to control the first and second Tx channels 612-1, 612-2 (and optional further Tx channels) to set phases of the FMCW radar chirps of the first chirp sequence and the second chirp sequence (and optional further chirp sequences) in accordance with a predefined DDM scheme. As shown in FIG. 6, the control circuit 620 may comprise respective analog (or digital) phase shifters 622-1, 622-2, and 622-3 for the respective Tx channels 612-1, 612-2, and 612-3.

Radar apparatus 600 may optionally additionally comprise a receiver circuit 630 for receiving reflections of the transmitted FMCW radar signals. Receiver circuit 630 comprises at least one Rx channel 632. The at least one Rx channel 632 is configured to receive a receive signal corresponding to reflections of the first sequence of FMCW radar chirps, the second sequence of FMCW radar chirps, and optional further sequences of FMCW radar chirps of optional further Tx channels. In the illustrated example, receiver circuit 630 does not only comprise one Rx channel 632, but four Rx channels 632-1, . . . , 632-4 for improved signal-to-noise ratio (SNR) and improved angular resolution. Receiver circuit 630 will be explained in more detail further below.

The skilled person having benefit from the present disclosure will appreciate that transmitter circuit 610 and receiver circuit 630 may be integrated or implemented separately and may include digital and analog circuit components used in FMCW radar transceivers, including but not limited to, for example, baseband circuits, mixer stages, RF circuits, Digital-to-Analog Converters (DACs), Analog-to-Digital Converters (ADCs), amplifiers, antennas, and the like.

According to the present disclosure, the FMCW waveforms or sequences of the plurality of Tx channels 612-1, 612-2, . . . may be combined with a predefined DDM scheme for Tx channel separation at the receiving side. For this purpose, the control circuit 620 (including respective phase shifters 622) may be configured to assign, to each Tx channel 612-1, 612-2, . . . , a unique sequence of phases applied to the respective sequence of FMCW chirps of the respective Tx channel. The phases for the respective unique sequence of phases for each Tx channel may generally be selected from an M-ary phase modulation alphabet, wherein M≥2 is an integer. M=2 would mean a binary phase modulation alphabet, for example with phases 0° and 180°, or 45° and 225°, or 90° and 270°, etc. M=4 would mean a quaternary phase modulation alphabet, for example with phases 0°, 90°, 180°, and 270°. The higher M, the more Tx channels may be separated. A sequence of phases applied to a chirp sequence may also be referred to as phase modulation vector.

FIG. 7 illustrates an example of a predefined DDM scheme for four Tx channels Tx1-Tx4.

In the illustrated example, the control circuit 620 is configured to assign a (single) first phase φ₁ to the FMCW chirps of the first chirp sequence of the first Tx channel 612-1 (Tx1). In the illustrated example, the first phase φ₁ is 0°. All P FMCW chirps of the first chirp sequence are transmitted with the first phase φ₁. The 1×P phase modulation vector for the first Tx channel 612-1 (Tx1) may thus be [φ₁, φ₁, φ₁, φ1, . . . , φ₁, φ₁]. The control circuit 620 is configured to assign eight different phases φ₁-φ₈ with a phase increment of +45° between successive phase values to the FMCW chirps of the second chirp sequence of the second Tx channel 612-2 (Tx2). In the illustrated example, the 1×P phase modulation vector for the second Tx channel 612-2 (Tx2) may thus be [φ₁, φ₂, φ₃, φ₄, φ₅, φ₆, φ₇, φ₈, φ₁, φ₂, φ₃, φ₄, φ₅, φ₆, φ₇, φ₈, . . . , φ₁, φ₂, φ₃, φ₄, φ₅, φ₆, φ₇, φ₈], with φ₁=0°, φ₂=45°, φ₃=90°, φ₄=135°, φ₅=180°, φ₆=225°, φ₇=270°, φ₈=315°. The control circuit 620 is further configured to assign four different phases with a phase increment of +90° between successive phase values to the FMCW chirps of the third chirp sequence of the third Tx channel (Tx3). In the illustrated example, the 1×P phase modulation vector for the third Tx channel (Tx3) may thus be [φ₁, φ₃, φ₅, φ₇, φ₁, φ₃, φ₅, φ₇, . . . , φ₁, φ₃, φ₅, φ₇], with φ₁=0°, φ₃=90°, φ₅=180°, and φ₇=270°. The control circuit 620 is further configured to assign two different phases with a phase increment of +180° between successive phase values to the FMCW chirps of the fourth chirp sequence of the fourth Tx channel (Tx4). In the illustrated example, the 1×P phase modulation vector for the fourth Tx channel (Tx4) may thus be [φ₁, φ₅, φ₁, φ₅, . . . , φ₁, φ₅], with φ₁=0°, φ₅=180°. The skilled person having benefit from the present disclosure will appreciate that FIG. 7 is merely an example of a DDM scheme and that many other phase modulation vectors are possible. The phase modulation vectors of the different Tx channels may be essentially orthogonal to each other.

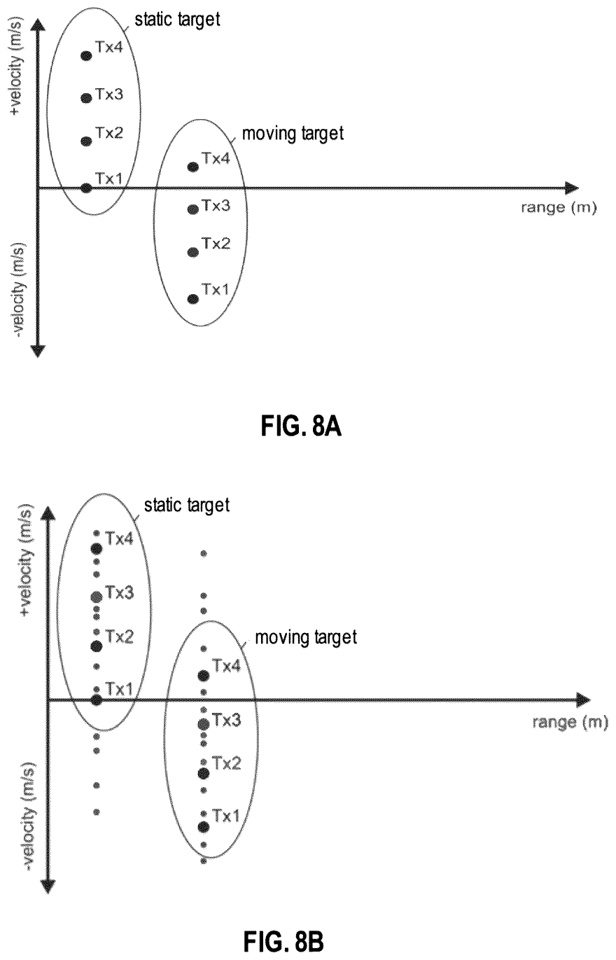

FIG. 8A illustrates an example of an ideal range-Doppler map for two targets-one static target at closer distance and one moving target at larger distance. Both targets are spread over four different Doppler bins (along the velocity axis) as the different phase modulation vectors of the different Tx channels translate to different velocities and hence Doppler bins. The lowest Doppler bin corresponding to the lowest velocity corresponds to Tx1. The Doppler bin corresponding to the next higher velocity corresponds to Tx2. The Doppler bin corresponding to the next higher velocity corresponds to Tx3. The Doppler bin corresponding to the highest velocity corresponds to Tx4.

As mentioned before, DDM requires accurate transmit phase shifters 622 to avoid artifacts such as spurs that degrade the radar system's performance. Inaccuracy of the transmit phase shifters 622 may create spurs along the axis of velocity, thus limiting the number of transmitters that can be switched on at the same time. Examples of such undesired spurs along the axis of velocity are shown in FIG. 8B.

Examples disclosed herein achieve that the undesired spurs along the axis of velocity may be reduced due to applying a scrambling phase code sequence to a conventional DDM scheme. This means that the first unique phase code sequence (first phase modulation vector) of the first Tx channel (Tx1) may be combined with the scrambling phase code sequence, the second unique phase code sequence (second phase modulation vector) of the second Tx channel (Tx2) may be combined with the same scrambling phase code sequence, the optional third unique phase code sequence (third phase modulation vector) of the third Tx channel (Tx3) may be combined with the same scrambling phase code sequence, and the optional fourth unique phase code sequence (fourth phase modulation vector) of the fourth Tx channel (Tx4) may be combined with the same scrambling phase code sequence. The combination of the respective scrambling phase code sequences (phase modulation vectors) with the scrambling phase code sequence results in a modified DDM scheme which will also be referred to as scrambled DDM scheme.

The scrambling phase code sequence denotes a sequence of phase values that may be superimposed with the respective unique phase code sequences (phase modulation vectors) of the DDM scheme. The scrambling phase code sequence common to all Tx channels. The scrambling phase code sequence may comprise (pseudo-) random scrambling phase code values or a (pseudo-) random order of scrambling phase code values.

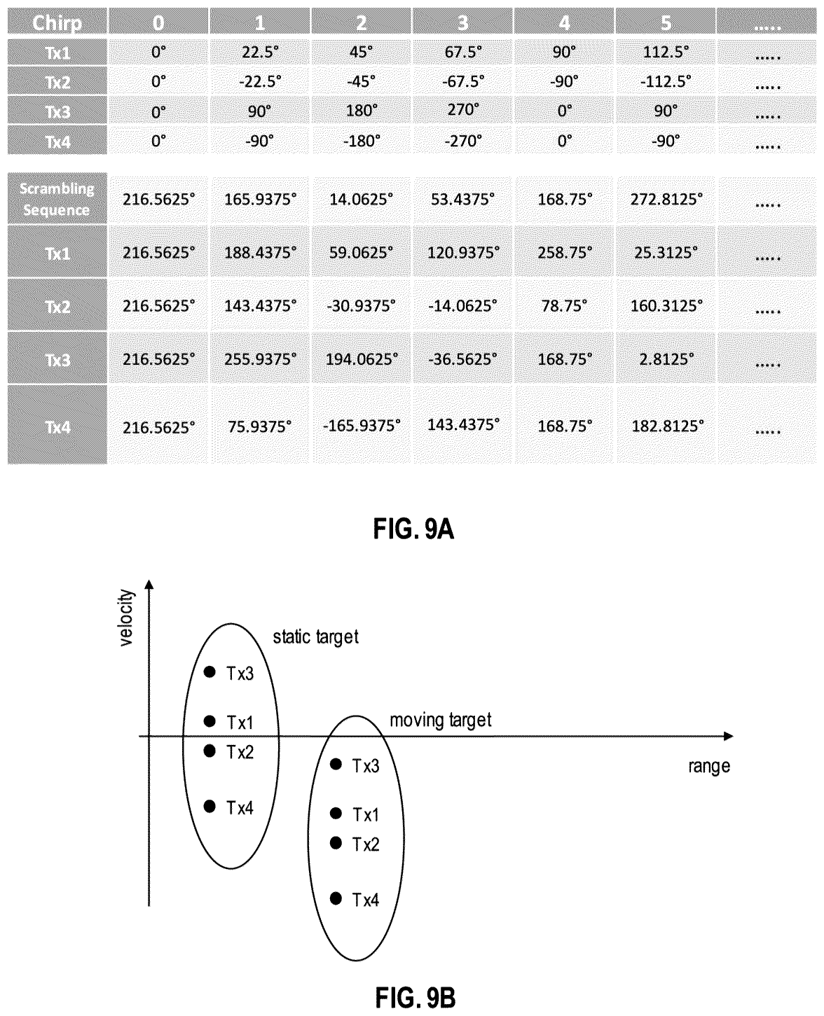

FIG. 9A illustrates another example of a predefined DDM scheme for four Tx channels Tx1-Tx4 together with a scrambling phase code sequence common to all Tx channels.

In the illustrated example, the control circuit 620 is configured to assign 16 different phase values φ₁-φ₁₆ with a phase increment of +22.5° between successive phase values to the FMCW chirps of the first chirp sequence of the first Tx channel 612-1 (Tx1). In the illustrated example, the 1×P phase modulation vector for the first Tx channel 612-1 (Tx2) may thus be [φ₁, φ₂, φ₃, φ₄, φ₅, φ₆, φ₇, φ₈, φ₉, φ₁₀, φ₁₁, φ₁₂, φ₁₃, φ₁₄, φ₁₅, φ₁₆, φ₁, φ₂, φ₃, φ₄, φ₅, φ₆, φ₇, φ₈, φ₉, φ₁₀, φ₁₁, φ₁₂, φ₁₃, φ₁₄, φ₁₅, φ₁₆ . . . , φ₁, φ₂, φ₃, φ₄, φ₅, φ₆, φ₇, φ₈, φ₉, φ₁₀, φ₁₁, φ₁₂, φ₁₃, φ₁₄, φ₁₅, φ₁₆], with φ₁=0°, φ₂=22.5°, φ₃=45°, φ₄=67.5°, φ₅=90°, . . . , φ₁₆=337.5°. The control circuit 620 is further configured to assign 16 different phases φ₁-φ₁₆ with a phase increment of −22.5° between successive phase values to the FMCW chirps of the second chirp sequence of the second Tx channel 612-2 (Tx2). In the illustrated example, the 1×P phase modulation vector for the second Tx channel 612-2 (Tx2) may thus be [φ₁, −φ₂, −φ₃, −φ₄, −φ₅, −φ₆, −φ₇, −φ₈, −φ₉, −φ₁₀, −φ₁₁, −φ₁₂, −φ₁₃, −φ₁₄, −φ₁₅, −φ₁₆, φ₁, −φ₂, −φ₃, −φ₄, −φ₅, −φ₆, −φ₇, −φ₈, −φ₉, −φ₁₀, −φ₁₁, −φ₁₂, −φ₁₃, −φ₁₄, −φ₁₅, −φ₁₆ . . . , φ₁, −φ₂, −φ₃, −φ₄, −φ₅, −φ₆, −φ₇, −φ₈, −φ₉, −φ₁₀, −φ₁₁, −φ₁₂, −φ₁₃, −φ₁₄, −φ₁₅, −φ₁₆], with φ₁=0°, φ₂=22.5°, φ₃=45°, φ₄=67.5°, . . . , φ₁₆=337.5°. The control circuit 620 is further configured to assign four different phases with a phase increment of +90° between successive phase values to the FMCW chirps of the third chirp sequence of the third Tx channel (Tx3). In the illustrated example, the 1×P phase modulation vector for the third Tx channel (Tx3) may thus be [φ₁, φ₅, φ₉, φ₁₃, φ₁, φ₅, φ₉, φ₁₃, . . . , φ₁, φ₅, φ₉, φ₁₃], with φ₁=0°, φφ₅=90°, φ₉=180°, and φ₁₃=270°. The control circuit 620 is further configured to assign four different phases with a phase increment of −90° between successive phase values to the FMCW chirps of the fourth chirp sequence of the fourth Tx channel (Tx4). In the illustrated example, the 1×P phase modulation vector for the fourth Tx channel (Tx4) may thus be [φ₁, −φ₅, −φ₉, −φ₁₃, φ₁, −φ₅, −φ₉, −φ₁₃, . . . , φ₁, −φ₅, −φ₉, −φ₁₃]. The skilled person having benefit from the present disclosure will appreciate that FIG. 9A is merely an example of a DDM scheme and that many other phase modulation vectors are possible.

Tx channels Tx1 and Tx2 and Tx channels Tx3 and Tx4 have the same DDM phase advancement rate, but they differ in sign. For example, a static target would be symmetrically to the range axis. In addition to these phase values, a random scrambling phase sequence may be generated and added to the existing phases in accordance with the present disclosure.

The respective sequences of FMCW radar chirps of the respective Tx channels may each comprise P chirps. Consequently, the respective phase modulation vectors of the DDM scheme may also each comprise P phase values. Typically, P may be selected as a power of 2, e.g., P=512 or P=1024. The example random scrambling phase code sequence [216.5625°, 165.9375°, 14.0625°, 53.4375°, 168.75°, 272.8125°, . . . ] depicted in FIG. 9A also comprises P phase values. The P phase values of the scrambling phase code sequence may be randomly distributed in the range from 0° to 360°.

The p-th (p≤P) phase value of the phase modulation vector for the first Tx channel 612-1 (Tx1) may be combined with the p-th phase value of the scrambling phase code sequence to obtain an p-th combined phase for the first Tx channel 612-1 (Tx1). The p-th phase value of the phase modulation vector for the second Tx channel 612-2 (Tx2) may be combined with the p-th phase value of the scrambling phase code sequence to obtain an p-th combined phase for the second Tx channel 612-2 (Tx2). The p-th phase value of the phase modulation vector for the third Tx channel (Tx3) may be combined with the p-th phase value of the scrambling phase code sequence to obtain an p-th combined phase for the third Tx channel (Tx3). The p-th phase value of the phase modulation vector for the fourth Tx channel (Tx4) may be combined with the p-th phase value of the scrambling phase code sequence to obtain an p-th combined phase for the fourth Tx channel (Tx4). The type of combination of the p-th phase value of the scrambling phase code sequence and the p-th phase value of the respective phase modulation vector may be identical for all Tx channels. In the illustrated example of FIG. 9A, the p-th phase value of the scrambling phase code sequence is added to the p-th phase value of the respective phase modulation vector to obtain the p-th combined phase for the respective transmit channel. The control circuit 620 is configured to control the respective phase modulators 622 to set the combined phases for the respective transmit channel Tx1-Tx4. The skilled person having benefit from the present disclosure will appreciate that the underlying DDM is not changed by the superimposed scrambling phase code sequence.

In the example of FIG. 9A, the control circuit 620 is configured to set phase values of the scrambling phase code sequence in accordance with a random distribution in a range from 0° to 360°. That is, the phase values of the scrambling phase code sequence are random values in the range from 0° to 360°. Alternatively, the control circuit 620 may be configured to the set phase values of the scrambling phase code sequence as uniformly or linearly distributed phases in a range from 0° to 360° but randomly distributed within the scrambling phase code sequence. Here, the phase values of the scrambling phase code sequence themselves are not random. However, positions of the uniformly distributed phase values within the scrambling phase code sequence may be random. For example, the phase values of the scrambling phase code sequence may first be calculated according to φₚ=p*360°/P (p≤P) and then be randomly distributed among the P chirps.

In the example of FIG. 9A, the scrambling phase code sequence may remain constant (unchanged) over time. In such a case, the scrambling phase code sequence as well as the phase modulation vectors of the DDM scheme may be stored in a memory (not shown) of the radar apparatus 600. Alternatively, the phase modulation vectors of the DDM scheme combined with the scrambling phase code sequence in the lower portion of FIG. 9A may be stored in the memory. Alternatively, the scrambling phase code sequence may change over time, e.g., among different chirp sequences or frames. This may further improve an even distribution of phase modulator errors. In this case, the radar apparatus 600 may further comprise a random number generator configured to generate a new scrambling phase code sequence per chirp sequence or frame. This means that the scrambling phase code sequence may not be predefined and thus be newly generated for subsequent time intervals.

In order to use the proposed concept, a radar MMIC may have flexible control of the phase modulator/PLL. For example, the MMIC may have a flexible sequencer that allows free programming of complex chirp/ramp programs.

FIG. 9B illustrates an example of an ideal range-Doppler map for the example of FIG. 9A and two targets-one static target at closer distance and one moving target at larger distance. Both targets are spread over four different Doppler bins (along the velocity axis) as the different phase modulation vectors of the different Tx channels translate to different velocities and hence Doppler bins. The lowest Doppler bin corresponding to the lowest velocity corresponds to Tx4. The Doppler bin corresponding to the next higher velocity corresponds to Tx2. The Doppler bin corresponding to the next higher velocity corresponds to Tx1. The Doppler bin corresponding to the highest velocity corresponds to Tx3. This is due to the fact that the phase modulation vectors of Tx1 and Tx3 rotate forward with different phase advancement rates and the phase modulation vectors of Tx2 and Tx4 rotate backward with different phase advancement rates (see FIG. 9A).

The received signal has to be demodulated by the random phase sequence for each receiver channel 632. This can be done, for example, in the time domain. Using a Hilbert transformation, a real-valued IF baseband signal can be converted into an analytic signal in order to subsequently perform a phase rotation with the random phase sequence. Subsequently, standard signal processing (RDM) may be continued only with the real-valued part. Thus, the receiver circuit 630 of the radar apparatus is configured to perform a demodulation (descrambling) based on a receive signal and the scrambling phase code sequence. This demodulation (descrambling) may be performed in the time domain and/or in the frequency domain.

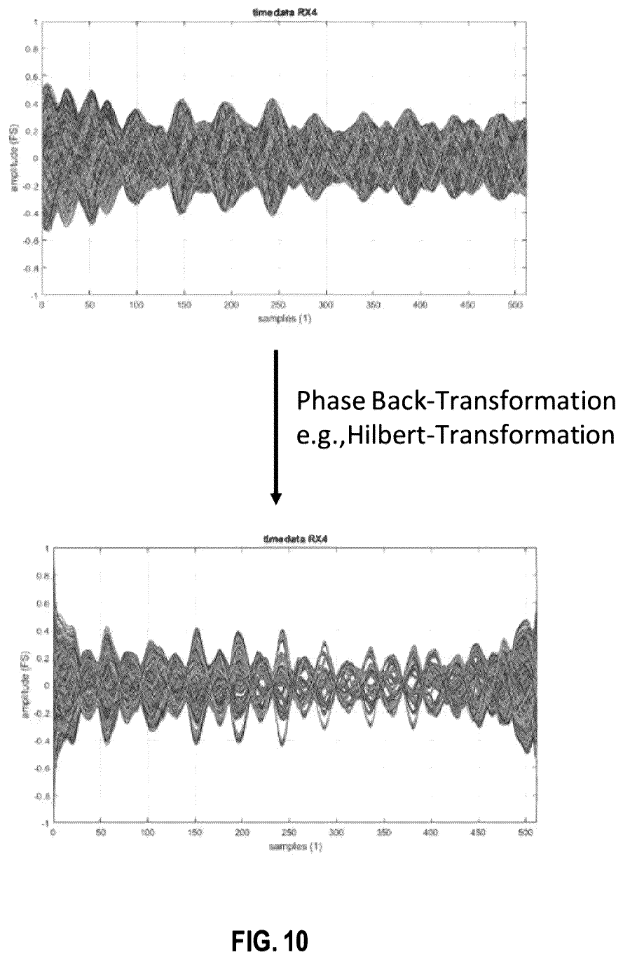

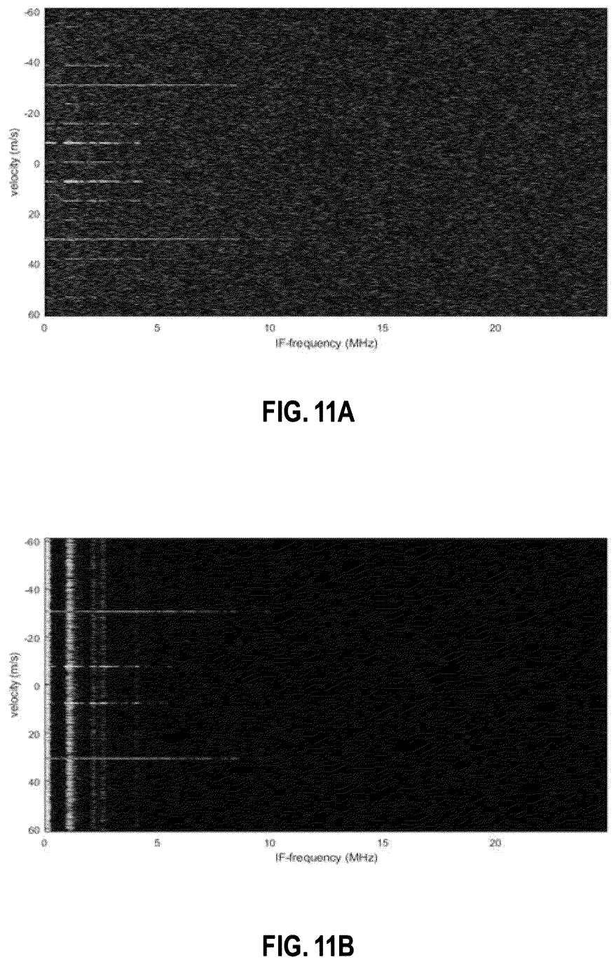

FIG. 10 shows an example of a receive signal for one Rx channel (here: Rx4). The example receive signal comprises a frame of 512 FMCW radar chirps and is a superposition of reflections of a frame of FMCW radar chirps transmitted from multiple Tx channels in accordance with implementations of the present disclosure, e.g., in accordance with a scrambled DDM scheme. FIG. 10 schematically illustrates a demodulation (descrambling) of the signal phase(s) in the time domain using a Hilbert transformation of the receive signal. The Hilbert transform may convert the time-domain receive signal into an analytic signal, which is a complex-valued signal, whose real part corresponds to the receive signal and whose imaginary part is the Hilbert transform of the receive signal. The analytic signal is a complex signal that has no negative frequency components and whose magnitude spectrum is equal to the magnitude spectrum of the receive signal. The analytic signal has a property that it can be decomposed into two parts: the real part, which is the original signal, and the imaginary part, which represents the Hilbert transform of the original signal. Therefore, the analytic signal can be used to extract the envelope and instantaneous frequency/phase of a modulated signal, which may be useful in signal processing applications such as demodulation. The analytic signal can be represented as a complex function of time, given by:

r(t)+jH{r(t)}

where r(t) is the real-valued receive signal and H {⋅} denotes the Hilbert transform operation.

Alternatively, the receiver circuit 630 may also be configured to perform the back-transformation/descrambling in the frequency domain after the range and/or Doppler FFT.

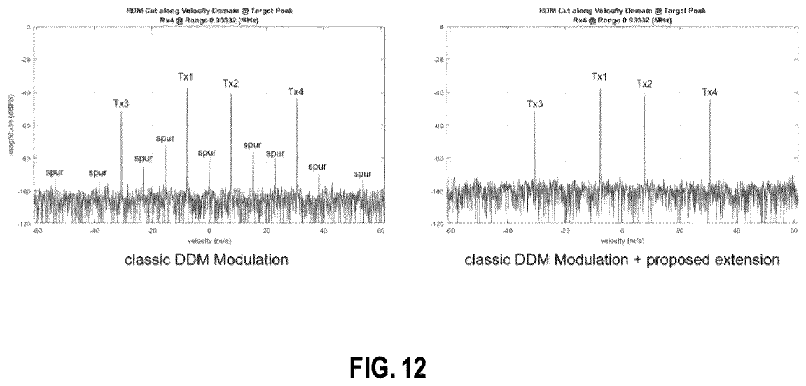

A possible result of the proposed scrambled DDM scheme is shown in FIGS. 11 and 12. FIG. 11A shows a Range-Doppler Map (RDM) based on conventional DDM. Due to spurs along the velocity axis, the four different Tx channels may not be clearly identified. FIG. 11B shows a range-Doppler map based on a scrambled DDM in accordance with implementations of the present disclosure. The proposed concept takes advantage of the fact that the energy in the unwanted spur components can be “smeared” along the velocity dimension. If a random phase sequence is added to the DDM modulation on all transmitters, the energy components of the spurs can be spread. The proposed concept is therefore an extension of the conventional DDM principle with an artificially imposed phase jitter. The advantage of this method is that the numerous, narrow-band spurs disappear and are spread over the entire velocity range, which results in a slight increase in the noise floor at the target distance. The slight increase of the noise floor is an effect which can be accepted in comparison to the number of unwanted spurs. The difference is even more noticeable when the RDM is cut along the speed axis at the distance of a target (see FIG. 12).

The two measurements were made with exactly the same settings, with the only difference being the scrambling of the DDM modulation with the method described here. Clearly visible is the elimination of the unwanted spurs due to the changed modulation.

While the above described examples relate particular to a DDM modulation scheme, it is to be noted that the proposed concept can be applied to any code based modulation scheme by adding a respective scrambling value to the respective code value. Furthermore, in some examples, the proposed concept may be combined with a Time Division Multiplexing (TDM) scheme. In such examples, the combined phase settings for each of the codes may not be transmitted at the same time but in accordance with the TDM at different times.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

### Aspects

The following provides an overview of some Aspects of the present disclosure:

Aspect 1: A radar apparatus, comprising: a transmitter circuit comprising a plurality of transmit channels and configured to: transmit, via a first transmit channel, a first sequence of FMCW radar chirps, and transmit, via a second transmit channel, a second sequence of FMCW radar chirps concurrently with the first sequence of FMCW radar chirps; and a control circuit configured to: control the first transmit channel and the second transmit channel to set phases of FMCW radar chirps of the first sequence of FMCW radar chirps and FMCW radar chirps of the second sequence of FMCW radar chirps in accordance with a phase modulation scheme, wherein the phase modulation scheme comprises: a first unique phase code sequence assigned to the first sequence of FMCW radar chirps according to the phase modulation scheme, wherein the first unique phase code sequence is combined with a scrambling phase code sequence, and a second unique phase code sequence assigned to the second sequence of FMCW radar chirps according to the phase modulation scheme, wherein the second unique phase code sequence is combined with the scrambling phase code sequence.

Aspect 2: The radar apparatus of Aspect 1, wherein: a p-th phase value of the first unique phase code sequence is combined with a p-th phase value of the scrambling phase code sequence, and a p-th phase value of the second unique phase code sequence is combined with the p-th phase value of the scrambling phase code sequence.

Aspect 3: The radar apparatus of any of Aspects 1-2, wherein: a p-th phase value of the scrambling phase code sequence is added to a p-th phase value of the first unique phase code sequence, and the p-th phase value of the scrambling phase code sequence is added to a p-th phase value of the second unique phase code sequence.

Aspect 4: The radar apparatus of any of Aspects 1-3, wherein the control circuit is configured to: select phase values of the scrambling phase code sequence in a range from 0° to 360°, control a first phase modulator of the transmitter circuit to set a combined phase for the first transmit channel, and control a second modulator of the transmitter circuit to set a combined phase for the second transmit channel.

Aspect 5: The radar apparatus of any of Aspects 1-4, wherein the control circuit is configured to: select phase values of the scrambling phase code sequence in accordance with a random distribution in a range from 0° to 360°.

Aspect 6: The radar apparatus of any of Aspects 1-5, wherein the control circuit is configured to: select phase values of the scrambling phase code sequence as uniformly distributed phases in a range from 0° to 360° and with randomly distributed positions within the scrambling phase code sequence.

Aspect 7: The radar apparatus of any of Aspects 1-6, wherein the control circuit is configured to: in a first time interval, apply the scrambling phase code sequence to the first sequence of FMCW radar chirps and to the second sequence of FMCW radar chirps, and in a subsequent second time interval, apply the scrambling phase code sequence to the first sequence of FMCW radar chirps and to the second sequence of FMCW radar chirps.

Aspect 8: The radar apparatus of any of Aspects 1-7, wherein the control circuit is configured to: in a first time interval, apply a first scrambling phase code sequence to the first sequence of FMCW radar chirps and to the second sequence of FMCW radar chirps, and in a subsequent second time interval, apply a different second scrambling phase code sequence to the first sequence of FMCW radar chirps and to the second sequence of FMCW radar chirps.

Aspect 9: The radar apparatus of any of Aspects 1-8, further comprising: a memory configured to store the first unique phase code sequence and the second unique phase code sequence and/or the scrambling phase code sequence, and/or a random number generator configured to generate one or more scrambling phase code sequences.

Aspect 10: The radar apparatus of any of Aspects 1-9, wherein the control circuit is configured to select phase values of the first unique phase code sequence and the second unique phase code sequence from an M-ary phase modulation alphabet, wherein M is an integer equal to or greater than two.

Aspect 11: The radar apparatus of any of Aspects 1-10, wherein the phase modulation scheme is a doppler division multiplexing (DDM) phase modulation scheme.

Aspect 12: The radar apparatus of any of Aspects 1-11, further comprising: a receiver circuit comprising at least one receiver channel configured to receive a receive signal corresponding to reflections of the first sequence of FMCW radar chirps and the second sequence of FMCW radar chirps, and wherein the receiver circuit is configured to perform a back-transformation based on the receive signal using the scrambling phase code sequence.

Aspect 13: A radar method, comprising: transmitting, via a first transmit channel, a first sequence of FMCW radar chirps; transmitting, via a second transmit channel, a second sequence of FMCW radar chirps concurrently with the first sequence of FMCW radar chirps; and controlling the first transmit channel and the second transmit channel to set phases of FMCW radar chirps of the first sequence of FMCW radar chirps and FMCW radar chirps of the second sequence of FMCW radar chirps in accordance with a phase modulation scheme, wherein the phase modulation scheme comprises: assigning a first unique phase code sequence to the first sequence of FMCW radar chirps according to the phase modulation scheme; combining the first unique phase code sequence with a scrambling phase code sequence; assigning a second unique phase code sequence to the second sequence of FMCW radar chirps according to the phase modulation scheme; and combining second unique phase code sequence with the scrambling phase code sequence.

Aspect 14: A system configured to perform one or more operations recited in one or more of Aspects 1-13.

Aspect 15: An apparatus comprising means for performing one or more operations recited in one or more of Aspects 1-13.

Aspect 16: A non-transitory computer-readable medium storing a set of instructions, the set of instructions comprising one or more instructions that, when executed by a device, cause the device to perform one or more operations recited in one or more of Aspects 1-13.

Aspect 17: A computer program product comprising instructions or code for executing one or more operations recited in one or more of Aspects 1-13.

1. Radar-A radar apparatus, comprising:
a transmitter circuit comprising a plurality of transmit channels and configured to:
transmit, via a first transmit channel, a first sequence of FMCW radar chirps, and
transmit, via a second transmit channel, a second sequence of FMCW radar chirps concurrently with the first sequence of FMCW radar chirps; and
a control circuit configured to:
control the first transmit channel and the second transmit channel to set phases of FMCW radar chirps of the first sequence of FMCW radar chirps and FMCW radar chirps of the second sequence of FMCW radar chirps in accordance with a phase modulation scheme, wherein the phase modulation scheme comprises:
a first unique phase code sequence assigned to the first sequence of FMCW radar chirps according to the phase modulation scheme, wherein the first unique phase code sequence is combined with a scrambling phase code sequence, and
a second unique phase code sequence assigned to the second sequence of FMCW radar chirps according to the phase modulation scheme, wherein the second unique phase code sequence is combined with the scrambling phase code sequence.

2. The radar apparatus of claim 1, wherein:
a p-th phase value of the first unique phase code sequence is combined with a p-th phase value of the scrambling phase code sequence, and
a p-th phase value of the second unique phase code sequence is combined with the p-th phase value of the scrambling phase code sequence.

3. The radar apparatus of claim 1, wherein:
a p-th phase value of the scrambling phase code sequence is added to a p-th phase value of the first unique phase code sequence, and
the p-th phase value of the scrambling phase code sequence is added to a p-th phase value of the second unique phase code sequence.

4. The radar apparatus of claim 1, wherein the control circuit is configured to:
select phase values of the scrambling phase code sequence in a range from 0° to 360°,
control a first phase modulator of the transmitter circuit to set a combined phase for the first transmit channel, and
control a second modulator of the transmitter circuit to set a combined phase for the second transmit channel.

5. The radar apparatus of claim 1, wherein the control circuit is configured to:
select phase values of the scrambling phase code sequence in accordance with a random distribution in a range from 0° to 360°.

6. The radar apparatus of claim 1, wherein the control circuit is configured to:
select phase values of the scrambling phase code sequence as uniformly distributed phases in a range from 0° to 360° and with randomly distributed positions within the scrambling phase code sequence.

7. The radar apparatus of claim 1, wherein the control circuit is configured to:
in a first time interval, apply the scrambling phase code sequence to the first sequence of FMCW radar chirps and to the second sequence of FMCW radar chirps, and
in a subsequent second time interval, apply the same-scrambling phase code sequence to the first sequence of FMCW radar chirps and to the second sequence of FMCW radar chirps.

8. The radar apparatus of claim 1, wherein the control circuit is configured to:
in a first time interval, apply a first scrambling phase code sequence to the first sequence of FMCW radar chirps and to the second sequence of FMCW radar chirps, and
in a subsequent second time interval, apply a different second scrambling phase code sequence to the first sequence of FMCW radar chirps and to the second sequence of FMCW radar chirps.

9. The radar apparatus of claim 1, further comprising:
a memory configured to store the first unique phase code sequence and the second unique phase code sequence and/or the scrambling phase code sequence, and/or
a random number generator configured to generate one or more scrambling phase code sequences.

10. The radar apparatus of claim 1, wherein the control circuit is configured to select phase values of the first unique phase code sequence and the second unique phase code sequence from an M-ary phase modulation alphabet, wherein M is an integer equal to or greater than two.

11. The radar apparatus of claim 1, wherein the phase modulation scheme is a doppler division multiplexing (DDM) phase modulation scheme.

12. The radar apparatus of claim 1, further comprising:
a receiver circuit comprising at least one receiver channel configured to receive a receive signal corresponding to reflections of the first sequence of FMCW radar chirps and the second sequence of FMCW radar chirps, and
wherein the receiver circuit is configured to perform a back-transformation based on the receive signal using the scrambling phase code sequence.

13. A radar method, comprising:
transmitting, via a first transmit channel, a first sequence of FMCW radar chirps;
transmitting, via a second transmit channel, a second sequence of FMCW radar chirps concurrently with the first sequence of FMCW radar chirps; and
controlling the first transmit channel and the second transmit channels to set phases of FMCW radar chirps of the first sequence of FMCW radar chirps and FMCW radar chirps of the second sequence of FMCW radar chirps in accordance with a phase modulation scheme, wherein the phase modulation scheme comprises:
assigning a first unique phase code sequence to the first sequence of FMCW radar chirps according to the phase modulation scheme;
combining the first unique phase code sequence with a scrambling phase code sequence;
assigning a second unique phase code sequence to the second sequence of FMCW radar chirps according to the phase modulation scheme; and
combining second unique phase code sequence with the scrambling phase code sequence.
